(19) United States
(12) Patent Application Publication
(10) Pub. No.: US 2008/0245788 A1
(43) Pub. Date: Oct. 9, 2008

(54) ELECTRIC APPLIANCE WITH INTERIOR LIGHTING

(76) Inventors: Vi-En Choong, Carlsbad, CA (US); Gerhard Kuhn, Koefering (DE); Feng Cheng, Shanghai (CN); Mathew Mathai, Monroeville, PA (US); Kar Phooi Foong, Shi Jia Garden (CN); Qi Chen, Shanghai (CN); Dmytro Poplavskyy, San Jose, CA (US)

Correspondence Address: FISH & RICHARDSON P.C., PO BOX 1022, MINNEAPOLIS, MN, 55440-1022, US

(21) Appl. No.: 11/952,029

(22) Filed: Dec. 6, 2007

(30) Foreign Application Priority Data
Dec. 8, 2006 (CN) 200610162072.1

(51) Int. Cl. H05B 6/64; H05B 6/00; H05B 6/72

(52) U.S. Cl. 219/758; 219/756; 219/763; 219/761; 219/757

(57) ABSTRACT

An electric appliance comprises in particular an interior space which is separable from an outside environment and at least one radiation-emitting device arranged in the interior space for emitting electromagnetic radiation into the interior space.

### BACKGROUND

The present invention relates to an electric appliance with interior lighting.

Appliances, such as refrigerators and ovens, are frequently formed with an interior light, which allows a user to see the contents of the appliance either when the door is open or closed.

### SUMMARY

An electric appliance with a radiation-emitting device is described.

According to at least one embodiment, the electric appliance includes an interior space separable from an outside environment, and a radiation-emitting device arranged in the interior space for emitting electromagnetic radiation into the interior space.

### BRIEF DESCRIPTION OF THE FIGURES

Further features, embodiments, and advantages are disclosed in the following in connection with the description of the exemplary embodiments in accordance with the figures.

FIG. 1 shows a schematic drawing of an electric appliance according to at least one embodiment.

FIGS. 2A and 2B show schematic drawings of a radiation-emitting device according to at least one further embodiment.

FIGS. 3 and 4 show schematic drawings of electric appliances according to further embodiments.

In the FIGS. similar elements or elements with similar functionalities are referred to by similar reference numerals. The shown elements, components and/or layers are not meant to represent exact dimensions and/or measures. dimensions and/or measures of elements, components and/or layers may be drawn exaggerated.

### DETAILED DESCRIPTION

In at least one embodiment, the outside environment is an ambient environment where the electric appliance is placed. The outside or ambient environment may provide ambient conditions which may comprise, for example, a temperature, humidity and/or an atmosphere. The outside environment may include a room or a building where the electric appliance is situated. The interior space may be separated from the outside environment so that the interior space is, for example, physically and/or thermally separated from the outside environment. Therefore, it may be possible to establish interior conditions in the interior space which can be different from the ambient conditions. “Physically separated” may imply that an exchange of particles, such as air or water, or electromagnetic radiation is reduced or prevented. For example the electromagnetic radiation which is emitted by the radiation-emitting device in and into the interior space may be prevented from irradiating the outside environment when the interior space is separated from the ambient environment.

In at least one embodiment, the electric appliance includes a door which separates the interior space from the outside environment when the door is closed. Opening the door connects the interior space to the outside environment. The electric appliance includes an opening which is covered by closing the door, thereby separating the interior space from the outside environment. Furthermore, the opening can be surrounded by a sealing, for example a rubber sealing, to seal the interior space from the outside environment when the door is closed.

In at least one further embodiment, the door includes an interior door surface which is arranged next to the interior space when the door is closed. In this case the interior door surface may form a border to the interior space and may face the interior space. It may be advantageous if the radiation-emitting device is positioned on the interior door surface, thereby being able to emit the electromagnetic radiation towards and into the interior space when the door is closed and towards the outside environment when the door is open. Furthermore, the radiation-emitting device may be formed as a part of the interior door surface or may be integrated in the door. Thereby, the radiation-emitting device may include a surface, such as a radiation out-coupling surface, which is at least a part of the interior door surface.

In at least one further embodiment, the electric appliance includes at least one wall which may form another border to the interior space and which has an interior wall surface. The at least one radiation-emitting device may be positioned on the interior wall surface or may be formed as a part of the interior wall surface. The radiation-emitting device may be integrated in the wall. The radiation-emitting device can include a surface, such as a radiation out-coupling surface, that is formed at least as part of the interior wall surface.

In particular, the electric appliance may include a plurality of walls which are arranged next to each other forming borders to the interior space in several directions. The interior space may be completely enclosed by the at least one wall or the plurality of walls and the door when the latter is closed.

The electric appliance may include a containment confining the interior space, wherein the containment includes at least one wall and/or the door.

In at least one further embodiment, at least one shelf is positioned in the interior space. Moreover, a plurality of shelves may be positioned in the interior space. The shelf or plurality of shelves may be useful to deposit and/or place objects at one height or at several heights in the interior space.

In at least one further embodiment, the radiation-emitting device is positioned on the shelf. The radiation-emitting device can be attached to a surface of the shelf or included in the shelf so that the radiation-emitting device may be formed as a part of the shelf surface. The electromagnetic radiation may be emitted into the interior space via a radiation out-coupling surface of the radiation-emitting device and/or via a surface of the shelf.

The shelf may include a material which is transparent to the electromagnetic radiation, for example glass or a transparent plastic, so that the electromagnetic radiation emitted by the radiation-emitting device can be transmitted through the shelf. Alternatively, the shelf may be opaque to at least a part of the electromagnetic radiation or may be able reflect at least part of the electromagnetic radiation.

The electric appliance may further include a holding element which may be used to position and/or to mount the shelf. For example, the holding element can include a support surface or a clamp which can support the shelf and keep it in position. In case the radiation-emitting device is positioned on the shelf, it may be advantageous if the holding element includes electrical connectors providing electrical connection to the at least one radiation-emitting device.

In at least one embodiment, the radiation-emitting device includes a plurality of radiation-emitting devices. The plurality of radiation-emitting devices may emit the same electromagnetic radiation or different electromagnetic radiation, such as different wavelengths of radiation. For example the plurality of radiation-emitting devices may be arranged on several positions on the interior wall surfaces and/or the interior door surface and/or on the at least one shelf in order to provide the electromagnetic radiation emission into the interior space at various different positions.

For example the electromagnetic radiation may include visible wavelengths. In this case the radiation-emitting device or the plurality of radiation-emitting devices may be used to illuminate the interior space or at least parts of the interior space. Furthermore, the electromagnetic radiation may be used to illuminate objects which are placed in the interior space, for example on the shelf. The visible electromagnetic radiation may provide a white-colored illumination impression for an observer. Alternatively, the illumination impression may be single-colored or mixed-colored or may include color and/or intensity gradients.

In at least one embodiment, the radiation-emitting device emits an electromagnetic radiation which is emitted when the interior space is separated from the outside environment. Furthermore the radiation-emitting device can stop emitting the electromagnetic radiation when the interior space is open to the outside environment, which means that the electromagnetic radiation is emitted only when the door is closed. The electric appliance may, for example, include a door-controlled switch which activates and deactivates the radiation-emitting device emitting the electromagnetic radiation whenever the door is closed or opened, respectively. Furthermore, the door-controlled switch may activate the radiation-emitting device when the door is closed and a time-controlled switch may deactivate the radiation-emitting device emitting the electromagnetic radiation after a certain time has elapsed.

In particular, it may be advantageous if the electromagnetic radiation includes ultraviolet wavelengths. For example, the ultraviolet wavelengths may be chosen in such a way that the first electromagnetic radiation has a germicide, viricide and/or bactericide effect when irradiating, for example, micro-organisms and/or germs so that the micro-organisms and/or germs may be prevented from being active. Therefore, the electromagnetic radiation advantageously may be used to sanitize, disinfect and/or purify the interior space, the air or gases in the interior space, the interior wall surfaces, the interior door surface, the shelf or shelves and/or objects which may be placed in the interior space. The described disinfection, sanitizing and/or purifying mechanism may be activated each time the door is closed and the interior space is separated from the outside environment.

In particular, objects that can be placed in the interior surface may include at least one of organic and inorganic materials, food and medical objects such as medical tools or implants. Furthermore, ice, water or any other liquid may be contained in the interior space and may be purified and/or sanitized when being irradiated by the electromagnetic radiation. For instance, in case of water the electromagnetic radiation can be used to treat the water while being deposited in the interior space to ensure that it is safe for drinking.

In at least one further embodiment, the door and the at least one wall or the plurality of walls which enclose the interior space are opaque to ultraviolet radiation.

Alternatively or additionally, the electromagnetic radiation may include infrared wavelengths. For instance, perishable goods or products such as organic objects and in particular food may be stored in the interior space. Once the food starts decaying there may be certain volatile components which leach from the food into the interior space. Because the volatile components may have certain unique infrared absorption signals, the absorption of specific infrared wavelengths can be detected by loss of intensity at that particular wavelength. Therefore, the electric appliance may further include a detector which is able to detect infrared wavelengths and which in particular is able to detect the absorption of the specific infrared wavelengths. The detector may send a message to a display in the interior space or outside the interior space which may then be used to provide information regarding the food decay to a user.

Furthermore, the radiation-emitting device may emit a different electromagnetic radiation which is emitted when the interior space is open to the outside environment, i.e., when the door is open. Additionally it might be advantageous that in this case the radiation-emitting device stops emitting the different electromagnetic radiation when the interior space is separated from the outside environment, in particular when the door is closed. As described above, the electric appliance may include a door-controlled switch which can be used to activate and deactivate the radiation-emitting device emitting the different electromagnetic radiation when the door opened and closed, respectively. The different electromagnetic radiation may include visible light and in particular white light in order to illuminate the interior space as described further above. Thus, the device can emit a first range of electromagnetic radiation when the door is open and a second range of electromagnetic radiation when the door is closed and the first range can be different from the second range, such as ranges that only partially overlap or ranges that are entirely non-overlapping.

In at least one further embodiment, the door or a wall is at least partially transparent to visible radiation. The door or wall therefore can include a window which is transparent to visible radiation. The window may be transparent to visible electromagnetic radiation and opaque to ultraviolet radiation. In such case it may be advantageous if the radiation-emitting device is able to emit visible radiation also when the interior space is separated from the outside environment, i.e., when the door is closed. Thus, it may be possible to enable a user to see the interior space and, for example, see objects placed in the interior space when the door is closed.

The radiation-emitting device may have any convenient shape, for instance a spot-like shape, a line-like shape or an area-like shape. For example, a spot-like shape may be suitable for a radiation-emitting device which is formed as point-like light source, whereas a line-like shape may be a shape that mainly extends either along a straight line in one direction or along a curved line. For example an area-like shape may be a panel with the shape of a polygon, a circle, an ellipse, or any combination thereof. A radiation-emitting device which covers an area can be a rectangular panel.

Furthermore, a radiation-emitting device may be positioned on more than one surface, for example on more than one interior wall surface. Thus, the radiation-emitting device may extend over two, three or more interior wall surfaces thereby covering at least partially the two, three or more interior wall surfaces. In particular, the two, three or more interior wall surfaces may not be parallel to each other. Therefore the radiation-emitting device may be bent and/or curved so that the interior wall surfaces line with the radiation-emitting device.

Furthermore, the radiation-emitting device may include an optical element. The optical element can be for instance a lens, a diffuser, or a wavelength converter.

In a further embodiment, the radiation-emitting device is an organic or inorganic radiation-emitting device, such as an organic or inorganic light-emitting diode or an electroluminescence foil.

In at least one embodiment, the organic radiation-emitting device includes an organic light-emitting diode. An organic light-emitting diode (OLED) may include an organic semiconductor layer or a semiconductor layer sequence with at least one organic layer and has an active area, which is able to emit electromagnetic radiation. The OLED may include a first electrode on a substrate and a second electrode, wherein the organic semiconductor layer or semiconductor layer sequence with the organic layer arranged between the first and second electrode. The substrate may be rigid or flexible and may include transparent or opaque material. The substrate may include glass, quartz, a plastic sheet or foil, metal, a metal foil, a wafer, or any combination or laminate thereof. The first and second electrode may be suitable for injecting holes or electrons in the active area which can recombine under emission of electromagnetic radiation in the active area. Therefore, one electrode may be formed as anode whereas the other electrode may be formed as cathode.

Furthermore, at least one of the first and the second electrode may include a transparent material, which is able to transmit the electromagnetic radiation emitted by the active area. The transparent material may include a transparent conducting oxide, a metal, or a conducting organic material. For example a transparent electrode maybe formed as anode which is able to inject positive charges (“holes”) into the active area or as cathode which is able to inject electrons into the active area. A transparent electrode which includes a transparent conducting oxide may for instance include a transparent conducting metal oxide as zinc oxide, tin oxide, cadmium oxide, titan oxide, indium oxide or indium tin oxide (ITO). Furthermore, as an alternative or in additional to binary compounds a transparent conductive oxide may include ternary compounds, such as two of Zn, Sn, Cd, Mg, In and Ga or O. Transparent conductive oxides may be p- or n-doped and serve as cathode or anode material. Alternatively or additionally, the transparent electrode may include a thin transparent metal layer. Suitable metallic materials may be, for example, aluminum, barium, indium, silver, gold, magnesium, calcium, lithium or combinations, compounds or alloys thereof. An electrode which includes metal may be transparent or opaque and may serve as anode or cathode material.

The organic semiconductor layer or the semiconductor layer sequence with at least one organic layer may include polymers, oligomers, monomers, organic small molecules or other organic non-polymer materials or combinations thereof.

In at least one embodiment, the organic radiation-emitting device includes an encapsulation, which protects the electrodes and/or the organic layer and/or the active area from being harmed by humidity or oxidizing substances, such as oxygen. The encapsulation may include a single layer or a plurality of layers, wherein the single layer or the plurality of layers include a planarization layer, a barrier layer comprising ceramic, a water and/or oxygen absorbing layer, or any combination thereof.

The radiation-emitting device may include a radiation out-coupling or transmitting surface. The radiation transmitting surface may be a (“bottom emitter”) where the device emits through a surface of a substrate, or a (“top emitter”) where the device emits through a surface of an encapsulation or a second electrode, which is arranged over the active area of the radiation-emitting device so that the active area is sandwiched between the substrate and the encapsulation or the second electrode. Alternatively, the radiation-emitting device may be formed as a bottom and top emitter at the same time.

In at least one embodiment, the radiation-emitting device is formed as an electroluminescent foil (ELF). An ELF may include an active area with an inorganic material which is based on zinc sulfide. The active area may be arranged between a first and a second electrode. The electrodes may have features or structures as the electrodes described above. The active area may include a suitable dopant, for instance copper or europium. The ELF may include plastic foils that sandwich the electrodes and/or the active area and that are formed as a substrate and/or encapsulation.

In particular, the active area of the radiation-emitting device, which may be an OLED or an ELF, can be structured in different sub-areas or components, which are able to emit electromagnetic radiation with different wavelengths and/or the same wavelengths at the same time or at different times. The active area can include a first group of sub-areas which are able to emit visible light, such as white light. Furthermore, the active area may include a second group of sub-areas which are able to emit ultraviolet or infrared light.

In particular, the first and/or the second electrode may be structured so that current and/or voltage may be applied either to the first sub-areas or to the second sub-areas or to both. Such a device may be suitable for both illuminating and sanitizing the interior space, or for illuminating the interior space and detecting infrared-absorbing components therein as described above. For example, a structured OLED or ELF may be particularly suitable as an illumination means and/or as a sanitizing means and/or as a detecting means and/or as a display. For example a structured OLED or ELF may include sub-areas with a pixilated structure where independently controllable radiation-emitting sub-areas are formed as pixels so that alpha-numeric and/or graphical information can be displayed by certain sub-areas used as display pixels. At the same time other sub-areas of the radiation-emitting device may serve as illumination or sanitizing means.

In at least one embodiment, a radiation-emitting device which includes an OLED or an ELF is flexible and/or bendable. Such a radiation-emitting device can be advantageously used to line or cover one or more flat or curved interior wall surfaces with a single radiation-emitting device. Alternatively, the radiation-emitting device may be rigid and flat or rigid and bent to align with a bent or curved interior wall surface. In particular, all interior wall surfaces may be lined or covered with one single radiation-emitting device or a plurality of radiation-emitting devices which may be flexible or rigid.

In a further embodiment, the radiation-emitting device includes an inorganic light emitting diode (LED). The LED may include an epitaxially grown semiconductor layer sequence on a substrate and may be based on an inorganic material such as InGaAlN. Alternatively, the semiconductor layer sequence may be based on InGaAlP or AlGaAs.

Alternatively or additionally the semiconductor layer sequence may also include other III-V-semiconductor material systems or II-VI-semiconductor systems or any combination of the described materials. The substrate may include features as the substrate described above. An LED may be formed as thin-film semiconductor chip.

The semiconductor sequence may include an active area which is formed as a pn-transition, a double hetero structure, a single quantum-well structure or a multiple quantum-well structure. The LED may include electrodes and/or electrical contacts which may have features and/or structures as described above.

In a further embodiment, the radiation-emitting device includes a housing and/or an optical component such as a lens, a diffuser and/or a wavelength converter. The housing may contain one or more of the LEDs, OLEDs and/or ELFs. A diffuser may be advantageously positioned in the radiation path of the radiation-emitting device in particular when a homogenous light and intensity impression by an external observer is desired. A diffuser may advantageously be used in combination with point-like and/or line-like LEDs, OLEDs, and/or ELFs. A wavelength converter in combination with a single-color radiation-emitting device may be advantageous in order to provide a mixed-colored or white light impression to a beholder.

In some embodiments, the radiation-emitting device includes a first component that is able to emit a first electromagnetic radiation and a second component that is able to emit a second electromagnetic radiation. For example the radiation-emitting device includes a first LED and a second LED which are arranged in a single housing. The first LED may be able to emit visible radiation whereas the second LED may be able to emit ultraviolet or infrared radiation. Such radiation-emitting device may be suitable to illuminate and sanitize the interior space as described above. A radiation-emitting device which includes a first and a second component or pluralities thereof may have features and functions as a radiation-emitting device with different sub-areas as described above.

In at least one embodiment, the electric appliance is a domestic appliance or device, a medical appliance or device and/or an industrial appliance or device.

In some embodiments, the electric appliance further includes a cooling device for cooling the interior space to a temperature that is lower than a temperature of the outside environment. For example, the electric appliance may include or be a refrigerator, a freezer, an icebox, a cold room or a cooling chamber.

In at least one embodiment, an electric appliance with a cooling device further includes an OLED or ELF display and/or an OLED as illumination means and/or sanitizing means and/or detecting means. In particular, an OLED or ELF can be used as a display to enable an alpha-numeric or graphical display for displaying information, or as a light source. OLEDs and ELFs may have the advantages of being able to operate at temperatures which range from very low temperatures to room temperature and above while maintaining fast response and high contrast even at very low temperatures. Furthermore, all above-mentioned radiation-emitting devices may operate while generating a low amount of heat while providing flexible form factors so that the emitted electromagnetic radiation is not easily blocked even when the interior space is full, such as when the interior space is filled, for example, with food or other objects. The radiation-emitting device may include a flexible substrate or a preformed substrate or housing that can match the form and shape of the interior space and/or of the interior wall surfaces. OLED lifetimes are much increased at low temperatures. Furthermore, an interior space at a low temperature may have a low level of humidity while the interior space may be left in the dark when separated from the outside environment, which may prevent degradation in particular of OLEDs.

In a further embodiment, the electric appliance further includes a connection for providing water to the interior space. Water can be enclosed in a confinement or containment which is a part of the interior space and/or the water may at least temporarily and/or partially be confined by the interior space. For example, the confinement might be a water dispenser in a refrigerator. Ultraviolet radiation emitted by the radiation-emitting device may be applied to purify the water contained in the interior space and/or in the confinement or containment.

In some embodiments, the electric appliance further includes washing or cleaning instruments and/or devices so that objects placed in the interior space can be cleaned or washed. For example, the electric appliance may be a washing machine or a dish washer. In particular, ultraviolet electromagnetic radiation may be applied when the washing machine or dish washer is running thereby sanitizing and purifying the water used for washing and/or cleaning. Alternatively or additionally, ultraviolet electromagnetic radiation may be emitted by the radiation-emitting device when the washing machine or dish washer is empty. This may be suitable for example to disinfect the interior space after operation of the washing machine or dish washer. Furthermore, clothes or objects which are placed in the interior space of the washing machine or the dish washer, respectively, may be illuminated by visible electromagnetic radiation emitted by the radiation-emitting device while the electric appliance is running. The clothes or objects placed in the interior space may be visible through a window in the door or in a wall of the electric appliance while the electric appliance is operated.

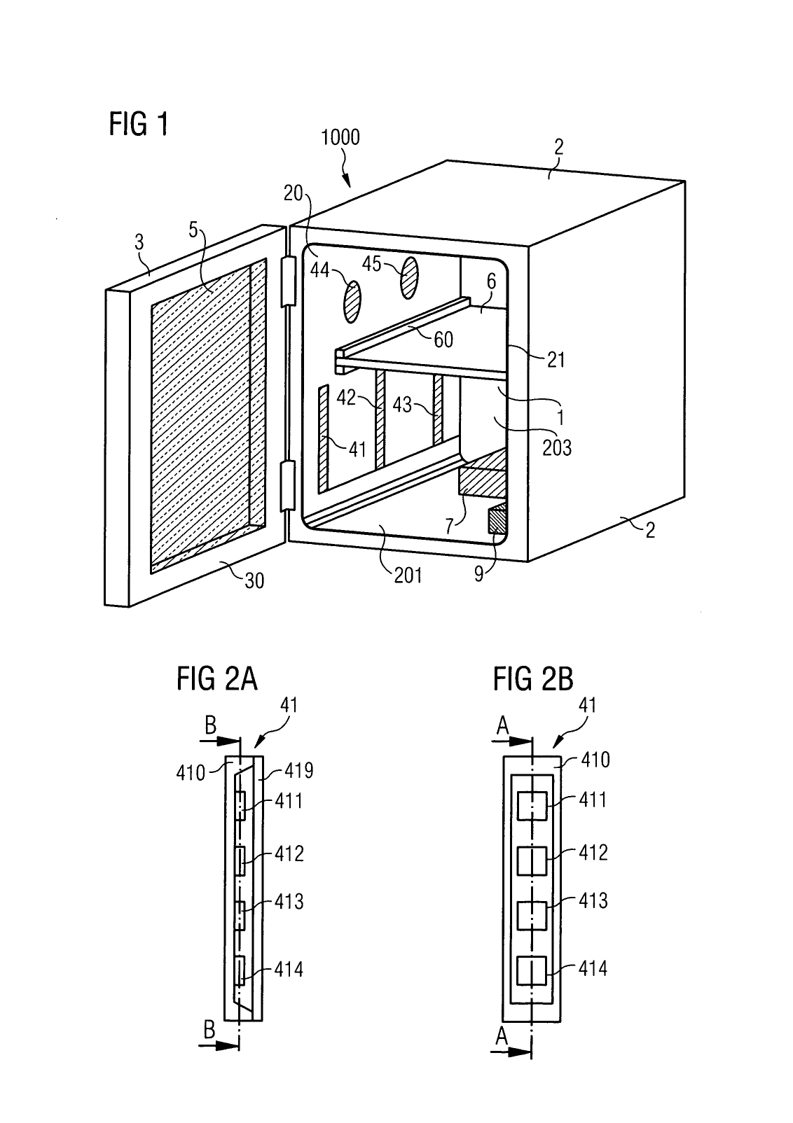

FIG. 1 shows an embodiment of an electric appliance 1000 according to at least one embodiment. The drawing is a schematic perspective view of the electric appliance 1000.

The electric appliance 1000 represents a refrigerator or a freezer comprising an interior space 1 which is enclosed by walls 2. An opening 21 is present, which can be closed by a door 3. The door 3 separates the interior space 1 from the outside environment when closed. The walls 2 and the door 3 form a confinement for the interior space 1. The walls 2 have interior wall surfaces 20, 201, 203 facing the interior space 1 and the door 3 has an interior door surface 30 facing the interior space 1 when the door 3 is closed. Furthermore, door 3 includes a window 5 through which the interior space 1 can be seen while the door is closed and the interior space 1 is separated from the outside environment.

Objects like food, which should be kept at low temperatures, may be placed in the interior space 1. A shelf 6 is mounted in the interior space 1 which may also serve as a support for objects in the interior space 1. The shelf 6 is supported by holding elements 60 which are fixed to interior wall surfaces 20 or which may be structures of interior wall surfaces 20. Due to the perspective viewing only one interior wall surface with holding elements 60 is visible. In order to cool the interior space 1 to a temperature which is lower than the temperature of the outside environment, the electric appliance 1000 includes a cooling device 7. Depending on the cooling ability of the cooling device 7 the electric appliance 1000 can be a refrigerator or a freezer.

The electric appliance 1000 further includes radiation-emitting devices 41, 42, 43, 44, 45, which are positioned on a wall 2. The positions and shapes of the radiation-emitting devices 41, 42, 43, 44, 45 shown in FIG. 1 are chosen only by way of example. The opposite interior wall surface 20 may also include radiation-emitting devices. Additionally or alternatively, radiation-emitting devices may be positioned on any other interior wall surface 20, 201, 203. Radiation-emitting devices 41, 42, 43 are line-shaped, whereas radiation-emitting devices 44, 45 are circular. The radiation-emitting devices 41, 42, 43 all include first components which are inorganic LEDs that emit a first electromagnetic radiation with a visible wavelength and further second components which are inorganic LEDs that emit a second electromagnetic radiation with an ultraviolet wavelength.

As an example of radiation-emitting devices 41, 42, 43, FIGS. 2A and 2B show a front and a side view of radiation-emitting device 41, respectively. The lines AA and BB in the figures denote the viewing plane of the other figure, respectively.

Radiation-emitting device 41 includes a housing 410 which supports inorganic LEDs 411, 412, 413, 414. In the particular embodiment shown in FIGS. 2A and 2B, the LED 414 is the first component of the radiation-emitting device 41. The LED 414 emits a first electromagnetic radiation, which is ultraviolet electromagnetic radiation. In particular, the wavelength of the ultraviolet radiation may be chosen to be a germicide, viricide and/or bactericide so that the interior space 1 can be disinfected and sanitized when LED 414 is powered. Furthermore, the LEDs 411, 412, 413 are formed as a second component of the radiation-emitting device 41 and are chosen to emit second electromagnetic radiation, which is visible electromagnetic radiation with a red, green and blue wavelength, respectively. The emitted visible electromagnetic radiation passes through an optical element 419, which includes a diffuser so that the electromagnetic radiation with the different visible wavelengths emitted by LEDs 411, 412, 413 are mixed and superposed. Therefore, the radiation-emitting device 41 can emit, for example white light as second electromagnetic radiation. Depending on the relative intensities of the electromagnetic radiation emitted by LEDs 411, 412, 413, respectively, a control of the emitted color is possible as the second component of the radiation-emitting device 41 may also emit colored electromagnetic radiation.

Alternatively, line-shaped radiation-emitting devices 41, 42, 43 can include one or more structured or unstructured OLEDs or ELFs with first and second sub-areas corresponding to the first and second components described above.

The first and second components of the radiation-emitting devices 41, 42, 43 are controlled by switch 9 (FIG. 1), which detects whether the door 3 is opened or closed. Switch 9 ensures that the first electromagnetic radiation, i.e., the ultraviolet electromagnetic radiation, is only emitted by the radiation-emitting devices 41, 42, 43 when the door 3 is closed, and that the radiation-emitting devices 41, 42, 43 stop emitting the first electromagnetic radiation when the interior space is opened to the outside environment. Thus, any user of the electric appliance 1000 can be protected against the ultraviolet electromagnetic radiation. Additionally, walls 2, door 3 and window 5 are opaque to ultraviolet electromagnetic radiation. Because the window 5 is transmissive to visible radiation, radiation-emitting devices 41, 42, 43 can be used to illuminate the interior space 1 and objects placed therein in both cases when the door 3 is opened or closed, respectively. Alternatively, the second component of the radiation-emitting devices 41, 42, 43 can also be controlled by switch 9 so that the second electromagnetic radiation is emitted only when the door is opened and the radiation-emitting devices 41, 42, 43 stop emitting the second electromagnetic radiation when the door is closed.

In order to control degradation of objects such as food in the interior space 1, the radiation-emitting devices 44, 45 can include inorganic LEDs and/or OLEDs that emit an infrared wavelength. On the interior wall surface 20 arranged opposite to and facing the radiation-emitting devices 44, 45 the electric appliance 1000 may include infrared detectors (not shown). Alternatively, the radiation-emitting devices 44, 45 include infrared detectors and the infrared electromagnetic radiation emitted by the radiation-emitting devices 44, 45 is reflected such as by a mirror on the interior wall surface 20 facing the radiation-emitting devices 44, 45. Additionally, the radiation-emitting devices 44, 45 may further include LEDs that emit visible radiation for further illuminating the interior space 1.

As the size of the electric appliance 1000 is not limited, the electric appliance 1000 can also be arranged as a cold room or cooling chamber.

Furthermore, an electrical appliance similar to the electric appliance 1000 may also be as a cleaning device, a dish washer or a washing machine, where the cooling device 7 is replaced by a connection for providing water to the interior space 1.

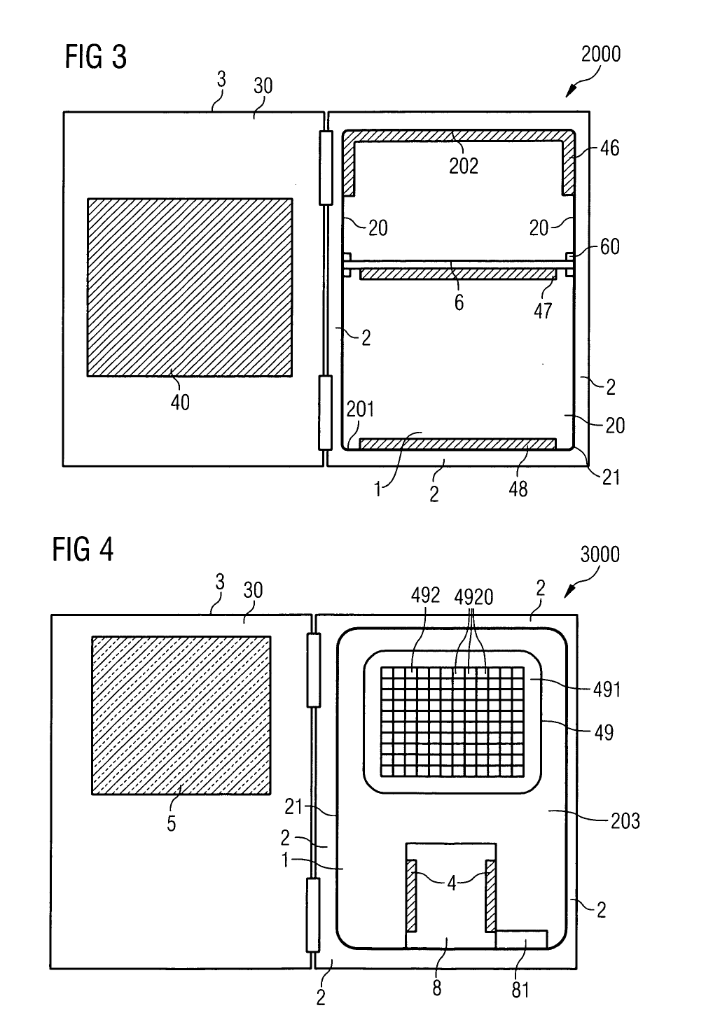

FIG. 3 shows a schematic drawing of a further embodiment of an electric appliance 2000 which is shown in a front view from the outside environment towards the opening 21. The door 3 is shown completely open. Because the functionality of the electric appliance 2000 may be similar to the previous embodiment, in the following only the differences are explained in detail.

In contrast to the embodiment shown in connection with FIGS. 1, 2A and 2B, the electric appliance 2000 includes a panel-like radiation-emitting devices 40, 46, 47, 48. The radiation-emitting devices 40, 46, 47, 48 include OLEDs and/or ELFs which are positioned on interior wall surfaces 20, 201, 202, on the interior door surface 30 and on the shelf 6, respectively, so that the interior wall surfaces 20, the interior door surface 30 and the shelf 6 are lined or covered by the radiation-emitting devices 40, 46, 47, 48, respectively. The radiation-emitting devices 40, 46, 47, 48 can include features as described herein. In particular, the radiation-emitting devices 40, 46, 47, 48 include first and second sub-areas which emit ultraviolet and/or infrared and visible, such as white, electromagnetic radiation, respectively. Therefore, each of the single radiation-emitting devices 40, 46, 47, 48 can be operated similar to the radiation-emitting devices 41, 42, 43, 44, 45 as described above.

In particular, the radiation-emitting device 48 covers the bottom interior wall surface 201 or can be integrated into the bottom interior wall surface 201 while the radiation-emitting device 40 covers the interior door surface 30. The radiation-emitting device 46 is bent and covers the top interior wall surface 202 and parts of the interior wall surfaces 20. It can be rigid and preformed or flexible to match the form of the interior wall surfaces 20, 202. The radiation-emitting device 47 is positioned on the shelf 6 and can illuminate and/or sanitize for example objects which are placed under the shelf 6 in the lower part of the interior space 6. Alternatively or additionally, the radiation-emitting device may also illuminate and/or sanitize the interior space 1 and/or objects which are placed on the shelf 6. The holding elements 60 include electrical conductors in order to electrically connect the radiation-emitting device 47 to a power source (not shown).

FIG. 4 shows a schematic drawing of a further embodiment of an electric appliance 3000, which is shown in a similar view as the preceding schematic drawing.

The electric appliance 3000 includes a window 5 in the door 3 through which a radiation-emitting device 49 can be seen by an external observer when the door 3 is closed and the interior space 1 is separated from the outside environment. The radiation-emitting device 49 includes an OLED which has first and second sub-areas 491, 492. The sub-area 491 includes organic material for emitting ultraviolet electromagnetic radiation for sanitizing and disinfecting purposes. The second sub-area 492 includes further sub-areas which are formed as pixels 4920. The sub-area 492 can serve as an illumination means when the plurality of pixels 4920 simultaneously emit visible electromagnetic radiation. Furthermore, the sub-area 492 can serve as an alpha-numeric or graphical display when the pixels 4920 are operated independently from each other. Due to the window 5 in the door 3, the displayed information can be observed even when the door 3 is closed. For example the sub-area 492 can display status information about the conditions in the interior space 1.

Alternatively or additionally, a radiation-emitting device 49 or at least a display similar to the sub-area 492 of the radiation-emitting device 49 can cover the interior door surface and in particular at least a part of the window 5. It can be formed to emit electromagnetic radiation through the window 5 as well as towards the interior space.

The electric appliance 3000 further includes a containment 8, which is positioned in the interior space 1. Although the containment 8 may be closed on all sides by walls, a front wall is not shown for explanation purposes. The containment 8 includes radiation-emitting devices 4 which emit ultraviolet electromagnetic radiation. In the embodiment shown in FIG. 4 the containment 8 is a water dispenser build into the electric appliance 3000 which is a refrigerator. Water can be provided to the water dispenser by means of a water connection 81.

Any of the radiation-emitting devices shown in the previous embodiments are by way of example only and can be replaced by any other radiation-emitting devices described in the specification.

The scope is not limited to the exemplary embodiments described herein. Any novel feature and any novel combination of features which include any combination of features which are disclosed herein as well as those stated in the claims, even if the novel feature or the combination of features are not explicitly stated in the claims or in the embodiments are meant to be covered.

1. An electric appliance, comprising:
one or more walls at least in part defining an interior space of the electric appliance separable from an environment outside of the electric appliance, and
at least one radiation-emitting device arranged in the interior space for emitting electromagnetic radiation into the interior space, wherein the radiation-emitting device is an organic light emitting diode or an electroluminescent foil.

2. The electric appliance according to claim 1, further comprising a door separating the interior space from the environment outside of the electric appliance.

3. The electric appliance according to claim 2, wherein:
the door has an interior door surface, and
the at least one radiation-emitting device is positioned on the interior door surface.

4-5. (canceled)

6. The electric appliance according to claim 2, wherein the door or at least one of the one or more walls is at least partially transparent to visible radiation.

7. The electric appliance according to claim 1, further comprising a shelf positioned in the interior space.

8. The electric appliance according to claim 7, wherein the at least one radiation-emitting device is positioned on the shelf.

9. The electric appliance according to claim 7, further comprising a holding element for positioning the shelf and providing an electrical connection to the at least one radiation-emitting device.

10. The electric appliance according to claim 2, wherein the door and at least one of the one or more walls are opaque to ultraviolet radiation.

11. The electric appliance according to claim 1, wherein the at least one radiation-emitting device comprises a plurality of radiation-emitting devices.

12. The electric appliance according to claim 1, wherein the electromagnetic radiation comprises at least one of ultraviolet, visible and infrared wavelengths.

13. The electric appliance according to claim 1, wherein the at least one radiation-emitting device is configured to emit a first electromagnetic radiation when the interior space is separated from the environment outside the electric appliance and to stop emitting the first electromagnetic radiation when the interior space is open to the environment outside the electric appliance.

14. (canceled)

15. The electric appliance according to claim 13, wherein the first electromagnetic radiation comprises ultraviolet or infrared wavelengths.

16. The electric appliance according to claim 13, wherein the at least one radiation-emitting device is configured to emit a second electromagnetic radiation when the interior space is open to the environment outside the electric appliance and the second electromagnetic radiation is different from the first electromagnetic radiation.

17. The electric appliance according to claim 16, wherein the radiation-emitting device is configured to stop emitting the second electromagnetic radiation when the interior space is separated from the outside environment.

18. The electric appliance according to claim 16, wherein the second electromagnetic radiation comprises visible wavelengths.

19. (canceled)

20. The electric appliance according to claim 1, wherein the at least one radiation-emitting device comprises an organic light-emitting diode (OLED).

21. The electric appliance according to claim 1, wherein the at least one radiation-emitting device comprises an electroluminescence foil (ELF).

22. The electric appliance according to claim 1, wherein the at least one radiation-emitting device comprises a first component that is able to emit a first range of electromagnetic radiation and a second component that is able to emit a different second range of electromagnetic radiation.

23. The electric appliance according to claim 1, wherein the electric appliance is a domestic appliance, medical appliance or industrial appliance.

24. The electric appliance according to claim 23, further comprising a cooling device for cooling the interior space to a temperature that is lower than a temperature of the environment outside the electrical appliance.

25. The electric appliance according to claim 1, further comprising a connection for providing water to the interior space, wherein the at least one radiation-emitting device is configured to emit the electromagnetic radiation to irradiate the water.

26. An electric appliance, comprising:
one or more walls at least in part defining an interior space of the electric appliance separable from an environment outside of the electric appliance; and
at least one radiation-emitting device arranged in the interior space for emitting electromagnetic radiation into the interior space, wherein the radiation-emitting device is a semiconductor device configured to emit ultraviolet or infrared wavelengths.

27. The electric appliance according to claim 26, further comprising a door separating the interior space from the environment outside of the electric appliance.

28. The electric appliance according to claim 27, wherein:
the door has an interior door surface, and
the at least one radiation-emitting device is positioned on the interior door surface.

29. The electric appliance according to claim 27 wherein the door or at least one of the one or more walls is at least partially transparent to visible radiation.

30. The electric appliance according to claim 26, further comprising a shelf positioned in the interior space.

31. The electric appliance according to claim 30, wherein the at least one radiation-emitting device is positioned on the shelf.

32. The electric appliance according to claim 30, further comprising a holding element for positioning the shelf and providing an electrical connection to the at least one radiation-emitting device.

33. The electric appliance according to claim 27, wherein the door and at least one of the one or more walls are opaque to ultraviolet radiation.

34. The electric appliance according to claim 26, wherein the at least one radiation-emitting device comprises a plurality of radiation-emitting devices.

35. The electric appliance according to claim 26, wherein the electromagnetic radiation comprises at least one of ultraviolet, visible and infrared wavelengths.

36. The electric appliance according to claim 26, wherein the at least one radiation-emitting device is configured to emit a first electromagnetic radiation when the interior space is separated from the environment outside the electric appliance and to stop emitting the first electromagnetic radiation when the interior space is open to the environment outside the electric appliance.

37. The electric appliance according to claim 36, wherein the first electromagnetic radiation comprises ultraviolet or infrared wavelengths.

38. The electric appliance according to claim 36, wherein the at least one radiation-emitting device is configured to emit a second electromagnetic radiation when the interior space is open to the environment outside the electric appliance and the second electromagnetic radiation is different from the first electromagnetic radiation.

39. The electric appliance according to claim 38, wherein the radiation-emitting device is configured to stop emitting the second electromagnetic radiation when the interior space is separated from the outside environment.

40. The electric appliance according to claim 38, wherein the second electromagnetic radiation comprises visible wavelengths.

41. The electric appliance according to claim 26, wherein the at least one radiation-emitting device comprises an organic light-emitting diode (OLED).

42. The electric appliance according to claim 26, wherein the at least one radiation-emitting device comprises an electroluminescence foil (ELF).

43. The electric appliance according to claim 26, wherein the at least one radiation-emitting device comprises a first component that is able to emit a first range of electromagnetic radiation and a second component that is able to emit a different second range of electromagnetic radiation.

44. The electric appliance according to claim 26, wherein the electric appliance is a domestic appliance, medical appliance or industrial appliance.

45. The electric appliance according to claim 44, further comprising a cooling device for cooling the interior space to a temperature that is lower than a temperature of the environment outside the electrical appliance.

46. The electric appliance according to claim 26, further comprising a connection for providing water to the interior space, wherein the at least one radiation-emitting device is configured to emit the electromagnetic radiation to irradiate the water.
